(19) United States
(12) Patent Application Publication
(10) Pub. No.: US 2009/0135005 A1
(43) Pub. Date: May 28, 2009

(54) Tracking and security system

(76) Inventor: David Novak, Mason, OH (US)

Correspondence Address: David J. Novak, # 305, 8400 Sugar Maple Drive, Mason, OH, 45040, US

(21) Appl. No.: 12/290,928

(22) Filed: Nov. 5, 2008

Related U.S. Application Data
(60) Provisional application No. 61/002,051, filed on Nov. 6, 2007.

(51) Int. Cl. G08B 1/08

(52) U.S. Cl. 340/539.26

(57) ABSTRACT

A tracking and security system comprising a signal device having one or more ferroelectric varactors are configured to passively receive RF signals of various frequencies. The RF signal is collected, converted, and stored in a database for tracking transportable items. The signal device will also contain microcapsules which will detect chemical, biological, radioactive, nuclear and/or explosive materials.

### CROSS-REFERENCE TO RELATED APPLICATION

This application claims the benefit of U.S. Provisional Application No. 61/002,051, filed on Nov. 6, 2007.

### BACKGROUND OF INVENTION

The present invention relates to a low cost, remote tracking and security system and, more specifically, to a system for tagging, tracking and securitizing transportable items via Radio Frequency (RF) signals and microencapsulated enzymes and other types of micro-encapsulations to prevent lost items and/or to detect chemical, biological, radioactive, nuclear and explosive (CBRNE) threats to people and items involved in any form of transit, including but not limited to seaports, airports, train and truck depots.

The use of RF signals in the form commonly known as Radio Frequency Identification Devices (RFID) is now widely employed to assist in tracking various transportable items, such as products in the supply chain of industry or personal travel luggage. However, RFID have been overly costly and difficult to implement. In addition, RFID fails to provide any mechanism for the identification of CBRNE threats, and therefore, RFID provides no security for personnel or items involved in various forms of transport.

Current efforts to extend RFID in various industries, such as consumer goods, have focused on hand held scanners and short range applications. Further application include incorporating such devices into systems for airport luggage tracking but in every case the use of such devices have proven overly costly and even harder to effectively and efficiently implement since there is no standardization of the hand held readers used to identify the RFID tags attached to the transported items and short range makes remote tracking and security impossible.

Therefore, a need exists for an inexpensive, easily integrated device capable of long and short range tracking of transportable items and detecting CBRNE threats to personal and national security that can be easily attached to such items and that can be used across all modes of transportation including airports and airplanes, seaports and ships, trains and trucks and all other transportable items such as luggage and cargo.

### SUMMARY

The present invention satisfies the need for an inexpensive, easily integrated system for tracking transportable items and/or detecting CRBNE threats that may be contained within, on or about such items at a low cost and in a highly efficient and precise manner. The system includes a signal device for transmitting a signal that does not require a connection to an external power source. The signal device comprises one or more ferroelectric varactors configured to receive RF signals including transient RF signals. The varactors such as disclosed herein are known as shown and described in U.S. Pat. No. 7,030,463 and US Patent Application Publication No. 2007/0024400 (U.S. application Ser. No. 11/543,655) and U.S. application Ser. No. 11/543,654, U.S. application Ser. No. 10/575,754 and U.S. Application No. 60/665,725, which are incorporated herein. The varactors may be individually tuned to facilitate the collection of a range of frequencies in the RF electromagnetic spectrum. The system uses either a global positioning systems and/or a triangulation methodology to precisely determine location of transportable items. The varactor(s) of the device relays the RF signal to a central database, where the transportable items in the signal specific information is stored, archived and available for review by authorized personnel to determine the location of said item at various points of contact while in transit. Specifically, in a preferred embodiment of the invention, a computer hardware and software system is incorporated in the system for use in managing RF signal transfer and providing a communication mechanism for tracking transportable items. In addition, the signal device contains microcapsules. The microcapsules such as disclosed herein are known as shown and described in U.S. Pat. No. 6,964,836, U.S. Pat. No. 6,620,571, U.S. Pat. No. 6,387,585, U.S. Pat. No. 6,127,084 and U.S. Pat. No. 6,037,094 and other related patents which are incorporated herein. When exposed to CBRNE threats or any activity source, such as biological, chemical, radiation, nuclear or explosives, the microcapsules are activated and an output in the form of a signal or image is created thereby allowing for easy detection by security and/or authorized personnel involved in every form of item transportation. The active substance may be released, detected or activated by any of the following mechanisms: photo-irradiation, thermal sensitization, pressure application, effect of friction, degradation of the wall/shell i.e. chemical or biodegradation, diffusion through the wall/shell and/or electric current. In another preferred embodiment, the CBRNE threat detection information is made known to authorized personnel through one or more of the aforementioned methods.

In one embodiment, the varactors are tunable varactors configured to accept widely broadcast RF signals including signals emanating from each specific tracking and security device or tag.

In another embodiment, the varactors may be tuned to receive RF signals in the frequency range from about 60 Hz to about 100 GHz.

In another embodiment, the varactors are constructed of ferroelectric material.

In another embodiment, the varactors are tunable electromagnetic band gap structures.

In another embodiment, the device is constructed to absorb and dissipate RF energy by converting the RF energy to a signal that is read, and deposited into a central database.

In another embodiment, the device does not require a connection to an external power source.

In another embodiment, the signal device is a thin film.

In another embodiment, the signal device is a tag.

A principle advantage of the subject invention is that it facilitates the transference of information for the tracking of transportable items to prevent loss or theft.

Another advantage of the subject invention is that it facilitates the detection of personal, property and national security threats such as chemical, biological, nuclear, radiation or explosives.

Another advantage of the subject invention is that it facilitates remote tracking and security of transportable items of distances greater than about 1000 feet and up to about 20,000 feet.

### BRIEF DESCRIPTION OF THE DRAWINGS

These and other features, aspects, and advantages of the present invention will become better understood with regard to the following description, appended claims, and accompanying drawings where:

FIGS. 1 (A), (B) and (C) is a block diagram of the tracking and security system showing the signal device of the present invention.

FIG. 2 is a block diagram of the signal device of the subject invention, which does not require a connection to an external power source and having a plurality of varactors for receiving RF signals and transferring and converting those signals to a computer system and database. Each varactor 102 may be tuned to receive a different and unique frequency RF signal emanating from a specific signal device and ranging from 60 Hz to 100 GHz.

FIG. 3 is a diagrammatic representation of the computer system, (hardware) for operating the system software of the present invention.

FIG. 4 is a diagrammatic representation of the structure and design of the system software for tracking and security of transportable items.

FIG. 5 is a diagrammatic representation of a single varactor.

FIG. 6 is a diagrammatic representation of the multiple layers of the core varactor

FIG. 7 is a diagrammatic of multiple varactors

FIG. 8 is a diagrammatic representation of the micro-encapsulation system of the device system.

FIG. 9 is a diagrammatic representation of a temporary tag

FIG. 10 is a diagrammatic representation of a permanent tag.

### DETAILED DESCRIPTION

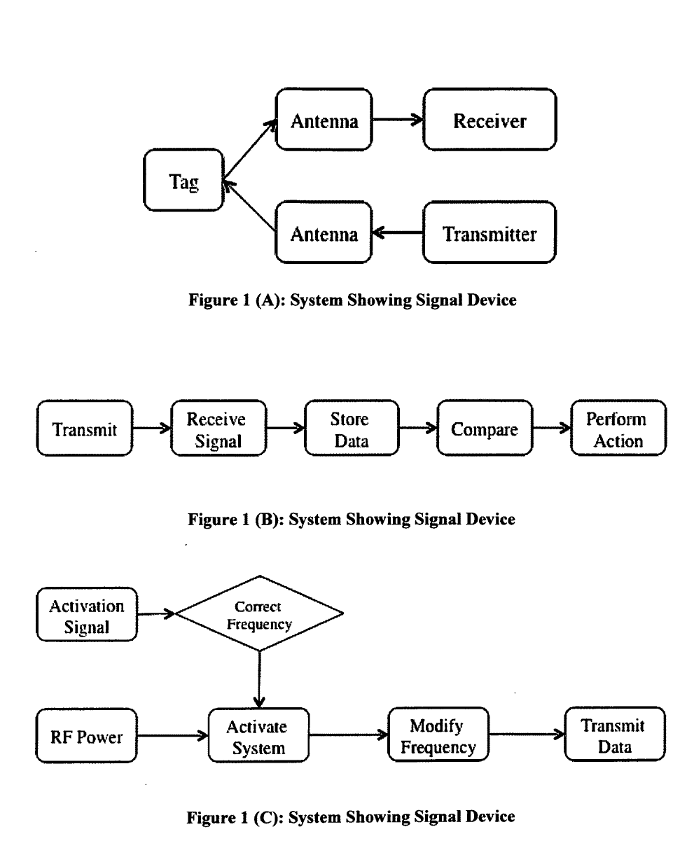

Referring to FIG. 1, the tracking and security system 10 comprising a signal device 100 having at least one varactor 102 in communication with a computer system and database 104. The varactor 102, which does not require an external power source, receives an RF signal, such as transient RF signal, and transfers and converts the signal into a form for deposit, archive and analysis into the database that can then be used to track items of transport.

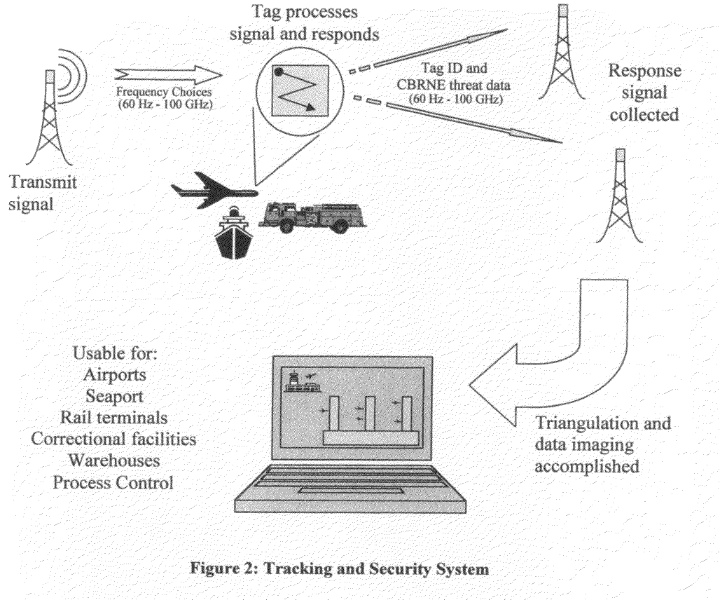

FIG. 2 shows another embodiment of the tracking and security system 10 in which the signal device 100 comprises a plurality of varactors 102 for receiving RF signals. In this embodiment each varactor 102 is tuned to receive a different unique RF frequency signal ranging from 60 Hz to 100 GHz and emanating from a specific signal device such as a tag. In this embodiment each individual device 102 may be connected to a single central database or several databases for specific signals 104, as shown in FIG. 2.

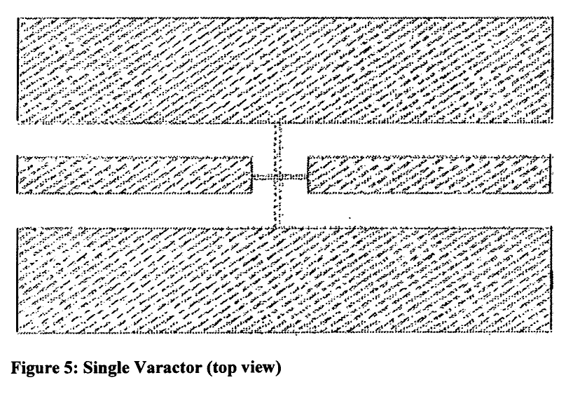

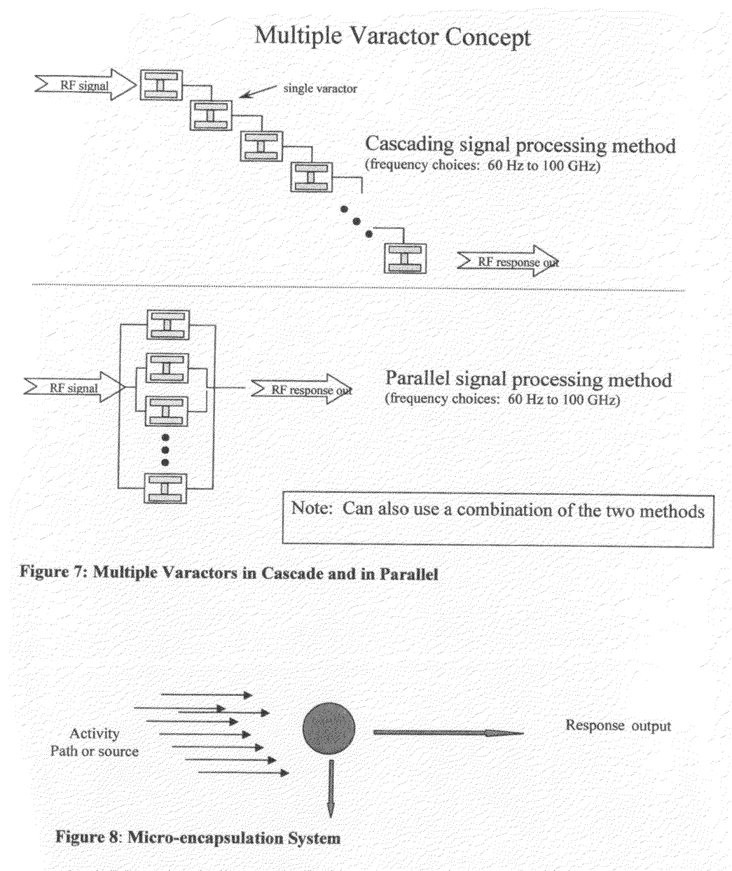

Further, each varactor 102 may be individually tunable to a specific RF signal frequency or may only receive an RF signal of a fixed frequency, as shown in FIG. 5, or may be used in a cascade or in parallel, as shown in FIG. 7.

In a preferred embodiment, the varactors 102 are capable of sending RF signals, to a specific database location.

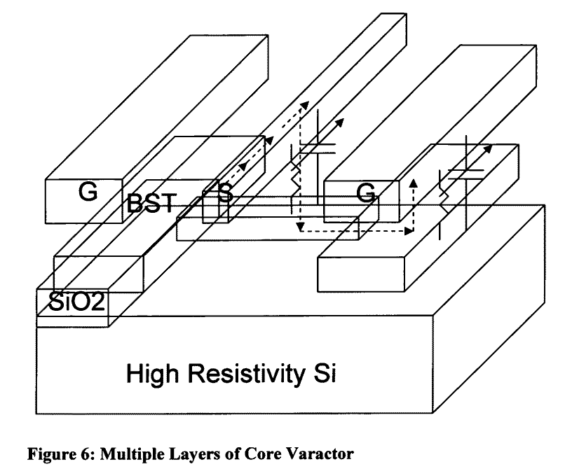

In another embodiment, the varactors 102 are constructed of ferroelectric materials. Such ferroelectric materials include, but are not limited to, barium strontium titanate (BSTO), as shown in FIG. 6.

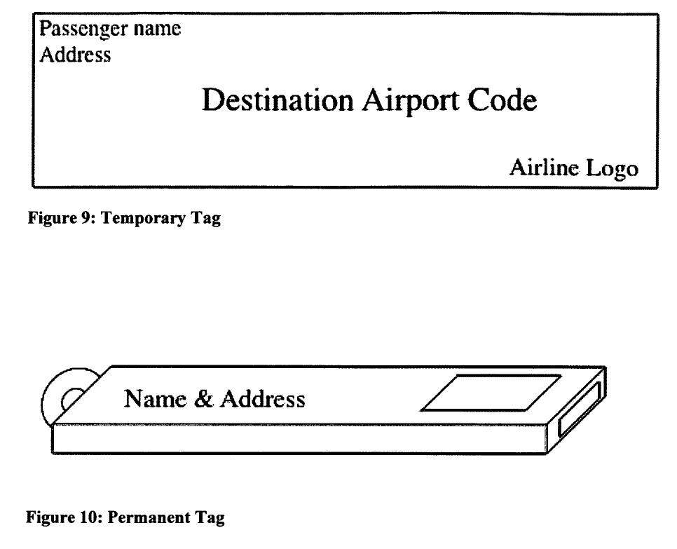

The signal device 100 may be configured as a thin film or a tag. The tag may be permanent or temporary, as shown in FIGS. 9 and 10.

The system of the present invention can be readily attached, adapted to and incorporated in various transportable items to provide wireless tracking capabilities without a required power source.

The signal device may be configured and tuned to absorb RF signals of a particular frequency or class of devices while allowing other RF signals to be transmitted or received. The blocking function may also be switched on or off to permit the transmission and reception of RF signals at specified times. Further, by preventing the transmission or reception of RF signals, the system may also serve as a security or counter-surveillance/counter-terrorism device for identifying CBRNE threats.

The signal device of the tracking and security system of the present invention can incorporate microcapsules to identify chemical, biological, radioactive, nuclear and explosive (CBRNE) threats, as shown in FIG. 8.

The present invention also facilitates the detection of CBRNE threats to persons, property and national security.

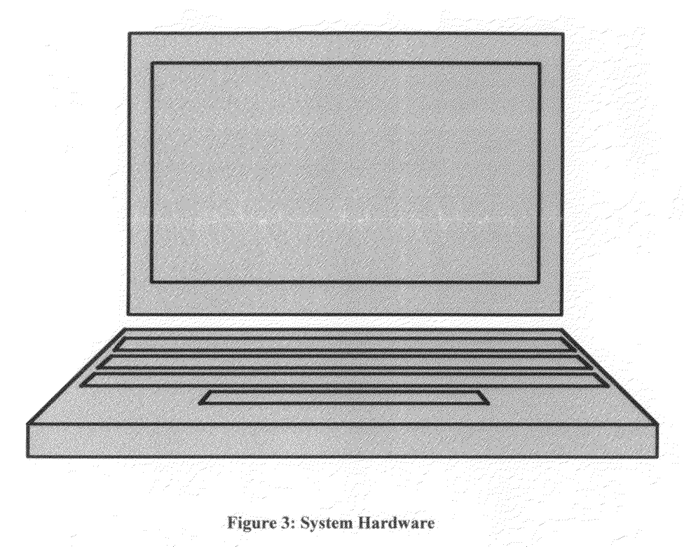

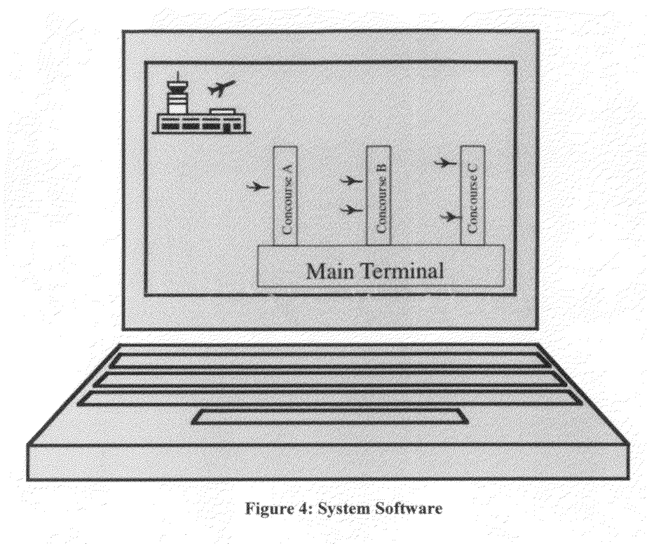

Referring to FIG. 3 and FIG. 4, a preferred embodiment of the system preferably utilizes system hardware and software to facilitate transfer of RF signals for tracking. Another preferred embodiment utilizes signals for communicating those specific CBRNE threat as identified by the tracking and security system, and more specifically, the microcapsules contained within the signal device, to notify and alert the proper and authorized personnel.

The previously described version of the present invention has many advantages, including the ability to collect and convert transient and/or targeted RF signals to specific databases and without connection to an external power source.

The present invention can also facilitate the location of transportable items.

The present invention also facilitates the selective absorption of RF signals to block specific RF signal transmissions.

Although the present invention has been described in considerable detail with reference to certain preferred embodiments thereof, other embodiments are possible. Therefore, the scope of the appended claims should not be limited to the description of the preferred embodiments contained herein.

What is claimed is:

1. A tracking and security system comprising a signal device for collecting and transferring RF signals as shown and described herein.

2. A tracking and security system comprising a device for collecting and transferring RF signals having at least one varactor in communication with at least one computer database wherein the varactor is capable of receiving an RF signal and transmitting a signal to a database.

3. The signal device of claim 2 wherein the at least one varactor is a plurality of varactors wherein each varactor is in connection with a central database.

4. The system of claim 1 wherein the signal device is effective for identifying and transferring CBRNE signals comprising at least one microcapsule.

5. The signal device of claim 4 for identifying and transferring CBRNE signals comprising at least one microcapsule that is capable of detecting chemical, biological, irradiation, nuclear and/or explosives.

6. The signal device of claim 4 wherein the microcapsule are capable of detecting CBRNE threats and engineered to send signals alerting personnel to the threat.

7. The signal device of claim 4 wherein several microcapsules walls will be made with polymers that will form the wall chemistry that will be used to detect several agents, which are sensitive to different organic groups.

8. The signal device of claim 4 wherein application of microcapsules are formed on chosen substrates and an output device is engineered to receive and output signals.

9. The signal device of claim 3 wherein the varactors devices are connected to a single database.

10. The signal device of claim 3 wherein each varactor device for tracking receives a different frequency RF signal.

11. The signal device of claim 2 wherein the at least one varactor is constructed from a ferroelectric material having a signal transfer to several databases.

12. The signal device of claim 6 wherein the ferroelectric material is BSTO or other advanced material such as polymers, microcapsules and microencapsulated enzymes.

13. The signal device of claim 3 wherein each varactor may be tuned to receive a specific frequency RF signal.

14. The signal device of claim 3 wherein the varactors receive RF signals in the frequency range of 60 Hz to 100 GHz.

15. The signal device of claim 3 wherein the varactors receive signals, in the frequency range of 60 Hz to 100 GHz.

16. The signal device of claim 3 wherein the varactors receive signals from long range of distances of about 1000 feet and up to about 20,000 feet.
